(19) United States
(12) Patent Application Publication
(10) Pub. No.: US 2017/0132374 A1
(43) Pub. Date: May 11, 2017

(54) System for Collecting Medical Data Using Proxy Inputs

(71) Applicant: Zyno Medical, LLC, Natick, MA (US)

(72) Inventors: Chao Young Lee, Weston, MA (US); Mei Zhang, Sharon, MA (US)

(21) Appl. No.: 15/347,146

(22) Filed: Nov. 9, 2016

Related U.S. Application Data
(60) Provisional application No. 62/253,962, filed on Nov. 11, 2015.

(51) Int. Cl. G06F 19/00; G06F 21/62

(52) U.S. Cl. CPC G06F 19/322; G06F 21/6254; G06F 19/3418; G06F 19/3468

(57) ABSTRACT

The present invention provides a system for collecting, anonymizing, and communicating information collected from medical pumps without the need for additional effort by medical care professionals. The pump/multi-pump derived information can be aggregated between hospitals and across healthcare institutions to provide global overviews of pump performance and drug use information. This information can assist with the delivery of healthcare by providing automatic guidance warnings, for example, deviating from established ranges for common delivery rates; trend monitoring to anticipate needs of the health care community based upon global health trends; and allocation of healthcare equipment by monitoring the total operating time and lifecycles of the pumps. Knowledge derived from this pump/multi-pump derived information can be used in an administrative capacity and to develop evolving advisory protocols for users of pumps comparing real-time pump protocols to those appropriate for a given drug.

### CROSS-REFERENCE TO RELATED APPLICATION

This application claims the benefit of U.S. provisional application 62/253,962 filed Nov. 11, 2015 and hereby incorporated by reference.

### BACKGROUND OF THE INVENTION

The present invention relates to systems for collecting, analyzing, and utilizing medical data for optimizing patient care, improving work flow efficiency, and enhancing compliance with regulations.

Accurate and timely record-keeping is an integral part of effective medical practice. Increasingly, this record-keeping is being moved from paper records to electronic media. Electronic media allows records to be more easily communicated and reviewed and permits increasing automation in the handling of the records and the delivery of healthcare.

It is reasonable to assume that in many areas the practice of medicine could be further improved with new and additional electronic data collection with respect to delivery of healthcare. Realistically, however, electronic data that is already collected, for example in the hospital electronic medical record, may not be readily available because of the high demands placed on the electronic medical record system for other purposes and the need for special programming outside of the intended use of the electronic medical record system to extract this data.

As more and more hospitals engage in evidence-based approaches to healthcare, electronic data collection may allow for data comparison between hospitals to help develop best practices for medical care. For example, aggregate data may allow medical personnel to view global trends in medical delivery to establish healthcare norms. Aggregate data may offer medical personnel the ability to develop actionable insights, organize future changes, and improve outcomes in, for example, patient care and hospital best practices.

One challenge with current electronic data collection is that preexisting hospital data systems are not structured or programmed for data sharing between hospitals or among different healthcare institutions for large scale aggregate data analysis. Hospitals often use different electronic data software which may be incompatible with other software or does not provide the capability to communicate or read each other's data. Moreover, without rewriting the programming completely, the preexisting structures do not allow for data sharing that adheres to healthcare privacy and security rules, such as provided by the Health Insurance Portability and Accountability Act (HIPAA).

### SUMMARY OF THE INVENTION

The present invention recognizes that the existing communication infrastructure between infusion pumps and a central database, for example, used for downloading information to the pumps, can be used to enlist the pumps for uploading data which, although not necessarily central to the delivery of medical care, can provide important insights into the operation of the healthcare facility to aid in improvement of healthcare delivery. Accordingly, the present invention provides a system for collecting, anonymizing, and communicating information collected from medical pumps without the need for additional effort by medical care professionals.

It is contemplated that the pump/multi-pump derived information can be aggregated between hospitals and across healthcare institutions to provide global overviews of pump performance and drug use information. This information can assist with the delivery of healthcare by providing informative reports on automatic guidance warnings, e.g., when deviating from established ranges for common delivery rates; trend monitoring to anticipate needs of the health care community based upon global health trends; and allocation of healthcare equipment by monitoring the total operating time and lifecycles of the pumps. Knowledge derived from this pump/multi-pump derived information can be used in an administrative capacity and to develop evolving advisory protocols for users of pumps comparing real-time pump protocols to those appropriate for a given drug.

In one embodiment of the present invention, a system for aggregating anonymous medical data includes a first set of medical pumps associated with a first medical institution having a first electronic medical record system; a second set of medical pumps associated with a second medical institution having a second independent electronic medical record system; and a data aggregating server; where each of the first and second medical pumps include a wireless communication link to an electronic computer executing a program to: (a) receive instructions for the delivery of drugs to patients by the pump; (b) monitor the operation of the pump during the delivery of drugs to the patient to provide monitor data; and (c) wirelessly communicate anonymous data selected from the monitor data and the instruction data to the data aggregating server for the production of aggregate medical data.

It is thus a feature of at least one embodiment of the invention to allow individual pump data to be gathered from multiple medical institutions for aggregate data analysis by medical administrators. The pump data is anonymized to preserve healthcare privacy while still delivering valuable information.

The electronic computer may further execute the program to: receive patient data for the patient receiving delivery of drugs, convert the patient data to anonymous patient data not identifying a particular patent, and wirelessly communicate the anonymous patient data to the data aggregating server. The patient data may be at least one of a patient identity and a patient demographic data and the step of converting the patient data to anonymous patient data replaces the patient identity with a unique anonymous identifier.

It is thus a feature of at least one embodiment of the invention to be able to sort and compare patients from aggregate hospital data by patient demographics such as age and gender.

The electronic computer may further execute the program to: receive a pump identification of the pump delivering the drug and wirelessly communicate anonymous pump identification to the data aggregating server.

It is thus a feature of at least one embodiment of the invention to link pump data to a pump identity to establish accumulated operating time of the pump and schedule maintenance or rotation of the pump.

The electronic computer may further execute the program to: receive hospital data related to the hospital carrying the pump, convert at least part of the hospital data to anonymous hospital data not identifying a particular hospital, and wirelessly communicate the anonymous hospital data to the data aggregating server. The hospital data may be at least one of a hospital identity and a healthcare organization characteristic and the step of converting the hospital data to anonymous hospital data replaces the hospital identity with a unique anonymous identifier.

It is thus a feature of at least one embodiment of the invention to link medical information to a particular hospital so that hospital data may be compared to other hospitals or institutions with similar characteristics.

The instruction data may be at least one of a drug identity, a drug dose, and a drug flow rate.

It is thus a feature of at least one embodiment of the invention to collect and store information normally delivered to pumps for pump operation.

The monitor data may be at least one of a volume of drug delivered and a time or date of delivery.

It is thus a feature of at least one embodiment of the invention to collect information that may related to pump operation.

The electronic computer may anonymize the data in a one-way hash function.

It is thus a feature of at least one embodiment of the invention to anonymize the medical data so that it cannot be inverted, keeping the medical information secure.

The data aggregating server may translate the anonymous data to a set of common data identifiers common to all pumps.

It is thus a feature of at least one embodiment of the invention to accommodate for different data formats of different medical institutions and the variety of different pumps which may be used therein.

An electronic computer communicating with the data aggregating server may execute a program to generate a report displaying the aggregate medical data in graphic form.

It is thus a feature of at least one embodiment of the invention to allow medical professionals to visualize hospital treatment protocols as compared to its peers.

An electronic computer communicating with the data aggregating server may execute a program to generate a report providing a total drug volume dispensed by a predetermined subset of medical pumps.

It is thus a feature of at least one embodiment of the invention to spot trends in drug delivery such as increased usage of drugs and predictive needs in drug inventory.

An electronic computer communicating with the data aggregating server may execute a program to generate a report of a common range of delivery rates for the aggregate medical data and produce an automatic alert when a delivery rate of a selected pump falls outside the common range.

It is thus a feature of at least one embodiment of the invention to provide guidance warnings which fall outside ranges of acceptable drug delivery values as established by aggregate delivery rates.

An electronic computer communicating with the data aggregating server may execute a program to generate a report of total operation time of a selected pump.

It is thus a feature of at least one embodiment of the invention to schedule maintenance of pumps and monitor life spans of pumps.

The present invention further provides a method for aggregating medical data from a plurality of medical institutions where each medical institutions has at least one medical pump having a housing adapted to receive an IV line, a pump for the delivery of liquid medicament through the IV line, an input device for receiving drug delivery data, and a data aggregating server, the method comprising the steps of: (a) transmitting drug delivery data to the input device of the pump; (b) monitoring the operation of the pump; (c) collecting at least one of the drug delivery data and monitor data; (d) anonymizing at least one of the drug delivery data and monitor data; (e) transmitting the anonymous data to the data aggregating server; and (f) collecting the anonymous data with other anonymous data to produce aggregate medical data of the pumps of the plurality of medical institutions.

The present invention further provides a system for aggregating anonymous medical data from multiple medical institutions including a first medical device associated with a first medical institution having a first electronic medical record system; a second medical device associated with a second medical institution having a second independent electronic medical record system; a data aggregating server; where each of the first and second medical devices include a wireless communication link to an electronic computer executing a program to: (a) receive operating instruction data for the medical device; (b) monitor the operation of the medical device to provide monitor data; (c) produce anonymous data selected from the monitor data and the operating instruction data; and (d) wirelessly communicate the anonymous data to the data aggregating server for the production of aggregate medical data.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

### BRIEF DESCRIPTION OF THE FIGURES

FIG. 1 is a block diagram of a multi-pump data collection system per the present invention providing wireless communication from medical pumps to a central hospital server and from there to an inter-hospital communication network;

FIG. 2 is a data flow diagram showing a processing of the information collected from the pumps in a centralized data collection system record for reporting to hospital administrators and downloading to the pumps;

FIG. 3 is a flowchart of a program executed in distributed fashion by the components of FIG. 1 for collecting, reporting, and using data of the centralized data collection system;

FIG. 4 is a logical diagram of the data structure of a database of the centralized data collection system;

FIG. 5 is a logical representation of a histogram generated from the data of the centralized database that may be reported, used for bedside guidance on pump settings, or the automatic generation of warnings;

FIG. 6 a logical representation of a trend line report that may be used to compare a given hospital to its peers with respect to anticipating drug usage;

FIG. 7 is a logical representation of a pump usage histogram useful for pump maintenance purposes; and

FIG. 8 is a logical representation of a report indicating relative proportions of different drugs delivered by pumps.

### DETAILED DESCRIPTION OF THE PREFERRED EMBODIMENT

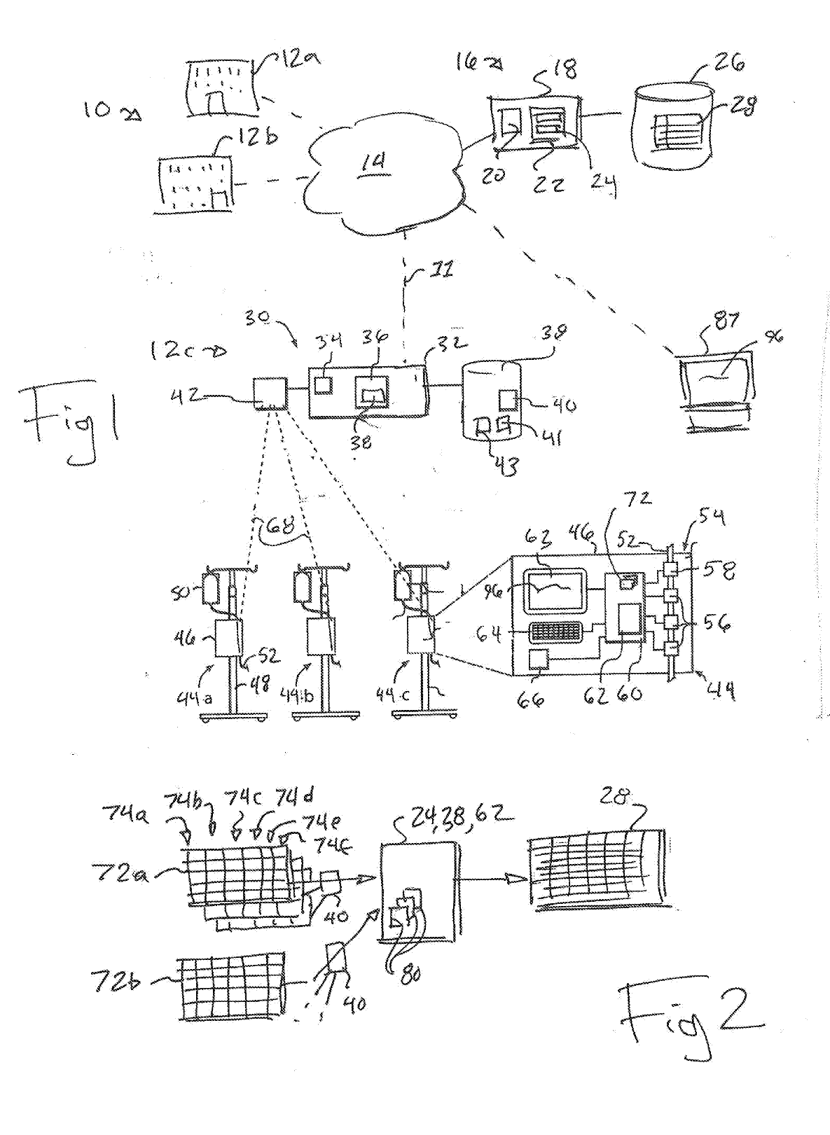

Referring now to FIG. 1, a medical infusion pump system 10 of the present invention may work with a variety of institutions 12a-12c, such as hospitals or the like, intercommunicating with a central data collection system 16 over inter-hospital communication network 11, for example, using the Internet 14.

The central data collection system 16 will generally include a network-connected computer 18 communicating over the Internet 14 with corresponding computers of the institutions 12a-12c. As is understood in the art, this network-connected computer 18 may include one or more processors 20 communicating with a memory 22. The memory 22 may hold programs 24 including generally a database program and a program executing some of the processes to be described with respect to the present invention. Generally, the network-connected computer 18 may also communicate with a mass storage data structure 26 such as a disk array implementing a database holding an aggregated data file 28 as will be described below. The network-connected computer 18 may also communicate with remote and local terminals for interacting with the central data collection system 16 as will be discussed below.

Each of the hospitals 12 may include a unique local server system 30 used for management of the data requirements of the hospital 12 such as billing records, electronic medical records and the like. Each separate hospital 12 or medical institution may be characterized as having a unique local server system 30 or electronic medical record system that may not be accessed by another separate hospital 12 without the inter-hospital communication network 11, for example, the Internet 14. Often the server systems 30 between institutions are incompatible using different coding, protocols and the like. The local server system 30, like the central data collection system 16, may include an Internet-connected computer 32 including one or more processors 34 communicating with a memory 36 also holding programs 38 typically used in the hospital including an electronic medical record system, drug libraries and the like. The programs 38 may also include programs used in implementing portions of the present invention as will be discussed.

The Internet-connected computer 32 may communicate with a mass storage memory system 39 holding specialized data files 40 collecting information used in the present invention. The mass storage memory system 39 may also hold other databases used by the hospital 12 including the electronic medical record system 41, patient billing systems, drug libraries 43, and the like.

The Internet-connected computer 32 may also communicate with one or more wireless access points 42 that may provide data connections to various equipment in the hospital 12 and in particular to one or more infusion pumps 44a-44c using known protocols such as IEEE 802.11 (a)/(b)/(g)/(n).

Referring still to FIG. 1, each medical pump 44 may provide, for example, a housing 46 that may be releasably attached to an IV pole 48, the latter that may support one or more IV bags 50 thereupon. The IV bag 50 may hold a saline or mineral solution or any of a number of intravenously administered medicines such as antibiotics for pain relief medicines.

An IV tube 52 may pass from the IV bag 50 through a pump section 54 of the housing 46 of the pump 44 to be received by peristaltic pump elements 56 and one or more sensors 58, for example, including sensors for pressure of the IV fluid, flow rate of the IV fluid, air inclusion within the IV fluid, proper seating of the IV tube, and the like, all generally understood in the art. The IV tube 52 may then pass out of the pump section to a needle assembly (not shown) for intravenous attachment to a patient.

Each of the pump element 56 and sensors 58 may connect to an internal controller 60 and execute a stored program 62 to provide control of the pump element 56 according to the program 62 and according to the readings of the sensors 58. The controller 60 may also communicate with user interface elements including a display screen 63 and a keypad 64 or the like, the latter being provided by membrane switches, a touchscreen, or the like. In addition, the controller 60 may communicate with a wireless network circuit 66 compatible with the wireless access points 42 described above for communication over a local hospital network 68.

In an alternative embodiment, one or more of the medical pumps 44 may be a “syringe pump” or an ambulatory pump having similar features to the infusion pump described above, for the introduction of medicines and the like.

In an alternative embodiment, one or more of the medical pumps 44 may be replaced with an interventional medical device or medical device, for example, monitoring heart rate, respiration, pulse, temperature, blood oxygen or the like.

During use of the pumps 44, a healthcare professional will confirm the proper patient identity and enter that confirmation as well as identification or confirmation of a drug being administered, a desired flow rate for that drug, a desired maximum volume to be delivered, and commands to begin, pause, restart, or conclude that delivery. Entry of the drug information may be compared against a master drug library downloaded into the pump from the local server system 30 according to techniques known in the art. This master drug library usually provides an absolute maximum and an absolute minimum delivery of the drug against which entered data may be compared. In more advanced systems, the pump 44 may receive drug identification and desired flow rate and dose volume, for example, from the local server system 30 managing drug orders, and this received information may be confirmed by a healthcare practitioner at bedside by viewing it on the display screen 63 and entering data through the keypad 64. The invention also contemplates that this data may be received through one or more sensors such as barcode scanners and near field sensors from the local environment including the label on the IV bag 50 and a wristband on the patient.

Referring now to FIGS. 1 and 2, the present invention provides routines in the program 62 so that this ancillary drug usage data 72 (providing drug identity 74a, programmed flow rate 74b for that drug, and maximum volume to be delivered 74c, as well as history 74d indicating beginning, pause and conclusion the delivery of the drug) contained in or received by the pump 44 are echoed back through the network 68 to be received by the local server system 30. Additional data such as patient identity 74e may also be included in this ancillary drug usage data 72 that may be subject to an anonymization as will be discussed below. This ancillary drug usage data 72 as collected is normally not used by the primary functions of the local server system 30 within the hospital 12 and may be stored in a specialized data file 40 with respect to the present invention. A given pump identifier 74f may also be recorded in the ancillary drug usage data 72 and optionally an identifier of a healthcare practitioner supervising the delivery of the medicament through the pump 44.

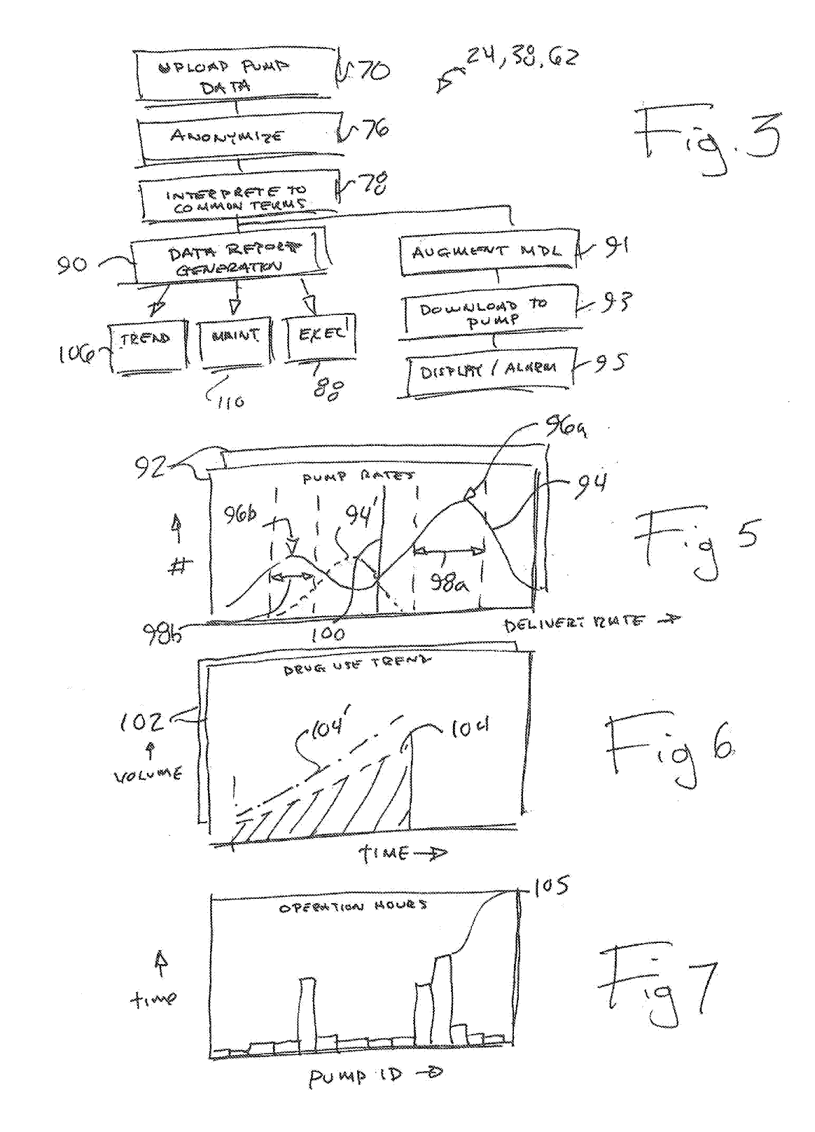

Referring now to FIGS. 1, 2 and 3, routines in the program 38 may then collect this information of the ancillary drug usage data 72 into a specialized data file 40 and then may send a specialized data file 40 through the Internet 14 to the central data collection system 16 as indicated by process block 70 of FIG. 3. The program represented in FIG. 3 will be implemented in distributed fashion through programs 24, 38, and 62.

Similar ancillary drug usage data 72 in specialized data files 40 and related to different health care organizations 12 may be obtained from those different health care organizations 12 including, for example, health care organizations 12a and 12b, and from every pump 44 in those hospitals.

As indicated by process block 76, this ancillary drug usage data 72 may be anonymized in certain key aspects during its collection or storage. Anonymization may include both encryption or removing personally identifiable information from the data sets so that the identifying data remains anonymous and cannot be linked back to the original data. With respect to anonymization of patient identification data, the following information may be removed from the patient data: names, geographical subdivisions smaller than a state, all elements of dates (except year), telephone numbers, fax numbers, electronic mail addresses, social security numbers, medical record numbers, health plan beneficiary numbers, account numbers, certificate/license numbers, vehicle identifiers and serial numbers, device identifiers and serial numbers, URLs, IP addresses, biometric identifiers (finger and voice prints), face photographic images, and other unique identifying numbers. In this respect, “direct identifiers” such as the patient's name, social security number, and email address may be removed along with any other “indirect identifiers” such as the patient's geographical subdivision, birthdate, and telephone and fax numbers that may be used in conjunction with other data held by or disclosed to the recipient that could identify the patient.

Patient identification 74 may be anonymized by, for example, a one-way hashing of the patient name or ID to a hash value so that downstream hash data for different patients may nevertheless be linked by a common hash without identification of those patients. As is understood in the art, a one-way hash is a one-way function that is easy to compute in a forward direction (converting the patient name to the hash) but practically impossible to invert (computing the patient name from the hash) even if the function is known. After one-way hashing, the patient is no longer identifiable although, multiple unidentifiable patients may be linked by a common hash.

Patient identification 74 may also be anonymized by grouping direct and indirect identifiers under large scale patient demographics, e.g., geographical regions larger than a state, patient gender, age, race or socioeconomic variables. Large scale patient demographics are considered to be large groups that would not allow the recipient to identify any particular patient identity. Through generalization techniques, direct identifiers and indirect identifiers may remain hidden.

In some smaller data sets, anonymity for small groups of demographics or groups with unique or rare characteristics may be compromised. For example, if only one or two people have a certain characteristic, it may be possible for the recipient to identify the patient. Anonymity can be preserved by removing or suppressing patient data that falls under a given threshold value. For example, remove the data of patients where the demographic identifies a group less than a threshold of, e.g., five people in the group.

Other methods of anonymization may include steps to de-identify the data which removes or obscures the patent data in a way that minimizes the risk of unintended disclosure to the recipient. De-identification may include record suppression, cell suppression, randomization, shuffling, creating pseudonyms or surrogate, sub-sampling, generalization, adding noise, character scrambling, character masking, truncation, encoding, blurring, masking, perturbation, and redaction.

Any one or more of these techniques may be utilized to anonymize the patient data before it is sent outside of the secure hospital environment to the recipient at the central data collection system 16.

At the point of transmission of the specialized data files 40 to the central data collection system 16, a hospital identification may be added to the specialized data files 40 which may also be anonymized, for example, by using predetermined health care organization identification numbers that may link the health care organizations to particular health care organization characteristics such as location, size, and health care organization type (teaching, etc.) without identifying the health care organization and by using generalization techniques. Large-scale identifiers such as location, size, and health care organization type may group the hospital data to provide better anonymization of any particular hospital identity. Pump identity information may be given a code unique to each health care organization and known only by the health care organization administration and a similar approach may be used with respect to the identity of the healthcare practitioners working with the pumps. Alternatively, the healthcare practitioners may be identified, for example, by department only. In this way a given pump and healthcare practitioner related to ancillary drug usage data 72 may be identified within a health care organization 12 and not external thereto and only for purposes of improving healthcare performance. Patient genomic information may also be added to the specialized data files 40 which may also be anonymized so that it cannot provide the identity of any particular patient identity.

At this time, before transmission of the specialized data files 40 to the central data collection system 16, the ancillary drug usage data 72 may be date and time stamped contemplating that it may not be forwarded immediately to the central data collection system 16 but may be transmitted, for example, on a daily basis at times when the local server systems 30 are less occupied. This date and time stamping may also be performed by the pumps 44 and is intended to provide a date and time of actual drug delivery.

At process block 78, implemented by the central data collection system 16, ancillary drug usage data 72 from the various health care organizations may be translated to a set of common data identifiers so, for example, similar drugs are referred to by identical identifiers in the data, common units of measurement are used, and the like. This translation process may also accommodate different data formats in specialized data files 40 (for example, differences in the assignments of fields) and idiosyncrasies in the collection of data by different types of pumps 44. In part, this interpretation may be performed by the program 62 in the pumps 44, which may map proprietary internal data commands in the pumps 44, for example, such as identify the starting, stopping, or pausing of treatment, to common data representations. For this purpose, the programs 24, 38, or 62 may incorporate script files 80 specially written for and associated with each health care organization 12 that provide for translation of the data received into a common format.

Referring to FIGS. 2 and 4, the result of this anonymizing and interpretation process is an aggregated data file 28 providing a multi health care organization data set including records for multiple drug deliveries (each represented as a row) including the fields 84a of drug identity 84b, of programmed flow rate for that drug 84c providing the intended dose in total volume 84d, anonymously identifying a given patient by a hash 84e, indicating a duration of the delivery 84f, indicating a time and date of the delivery 84g, and indicating a health care organization such as may link to additional general health care organization characteristics, such as number of beds, geographic location, type, etc. An identity of each pump 44 and the healthcare professional administering the drug may also be provided. A different record may be associated with each starting and stopping of the pump during a given drug delivery.

It will be appreciated that other data may also be collected from the pumps 44 when that data is available from either the pump 44 or from patient records of the electronic medical record system 41 indexed by the patient information available from the pump 44. This information may include patient weight, patient gender, drug concentration, delivery mode (bolus versus continuous), bolus limits, and occlusion levels.

Referring now to FIGS. 3, 4 and 5, the data of the aggregated data file 28 as indicated by process block 90 may then be processed to provide for data for the guidance of the delivery of healthcare. For example, reports may be produced providing information that is available by analyzing the aggregate data file 28 but would not be visible from individual data alone.

As shown in FIG. 5, data files 92 may be collected for each given drug (from field 84a) to provide a histogram 94 showing the frequency of given delivery rates (from field 84b) for the particular drug. This histogram 94 may, for example, show a most common delivery rate 96 (e.g., milliliters per hour) and may be multimodal showing, for example, two common delivery rates 96a and 96b. The information represented by the histogram may be incorporated in a drug library for users to select and/or modify before carrying out the treatment. The data for generating such histogram may be updated with a specific time interval, specific health care organization, even specific patient, etc. The drug library may be updated with as specific time interval, or triggered by an event. The drug library may be downloaded to the pump, and/or be stored in the database. Also, in this regard, multiple records in the aggregated data file 28 each indicating starting and stopping of a given drug delivery may be aggregated, for example, by proximity and time so as to prevent a greater weighting of deliveries that have multiple interruptions. Information relating to common delivery rates may be used to establish a best practice with respect to delivery of drugs.

This information of data files 92 may be used to augment a master drug file per process block 91 such as is downloaded to the pumps 44 as shown by process block 93. At the pumps 44 this data may be used to prepare automatic guidance warnings at the pumps 44, for example, by establishing a range 98a and 98b around the most common delivery rates (for example, one standard deviation) and testing whether the pump parameters entered by the attending healthcare professional fall within this range. If not a warning such as a tone or display may be provided, for example, as indicated by process block 95.

Alternatively this information may be displayed graphically on the display screen 63 of the pump 44 (shown in FIG. 1) and the particular pump parameters that have been set by the attending healthcare professional indicated, for example, by means of a cursor bar 100 to provide guidance to the healthcare professional as to the proper settings for a particular drug being delivered, also indicated by process block 95.

Data of these data files 92 may also be presented graphically, for example, to hospital administrators communicating with the data collection system 16, for example, through a dynamic webpage or the like accessed by a remote terminal 87 (shown in FIG. 1) as indicated by report block 88. In this regard, a report to a hospital administrator may show a first histogram 94 representing all other institutions of like size and location (and thus making information from each hospital anonymous) and a second histogram 94′ showing that particular institution for which the administrator is responsible (decoded by the central data collection system 16 to preserve the anonymity of all hospitals but the hospital receiving the report). This report allows the administrator to assess his or her hospital's treatment protocols with respect to its peers.

Similarly, and referring to FIG. 8, a chart 89 (for example, a pie chart) can be developed showing, either for a given health care organization or the health care organization cohort in general, those drugs which are most frequently delivered by pumps 44. While this data of FIGS. 5 and 8 is not necessarily critical for healthcare delivery, it provides important information for the improvement of healthcare delivery without burdening the physician or healthcare practitioners.

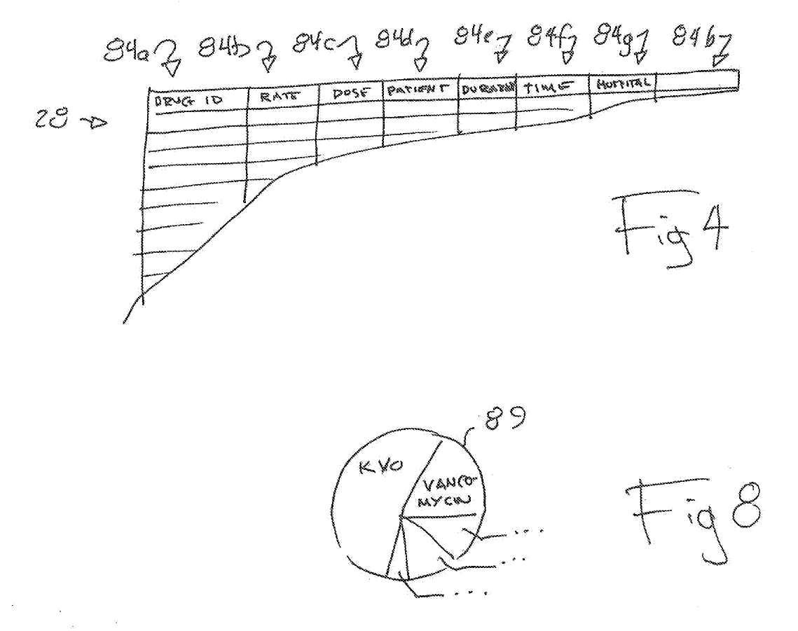

Referring to FIGS. 3 and 6, the ancillary drug usage data 72 collected from the pumps 44 may also be used for trend monitoring, for example, to anticipate needs of the health community based on early signals about health derived from ancillary drug usage data 72 for a given geographical area. In this case, for example, a report 102 may be developed, for example, as indicated by process block 106, for one or more drugs indicating the total volume dispensed by a given health care organization over a certain time period providing a trend line 104 and the corresponding trend line 104′ by the health care organization's peer group in the area. This report may help spot trends, for example, in the increased usage of certain drugs, which permits proactive measures such as identifying generics or evaluating the efficacy of other alternatives. Early information of this kind can be used to better predict the healthcare needs of the community to the extent that it reveals broader healthcare trends allowing better anticipation of the needs of the health care organization in terms of personnel and drugs. To the extent that the area under the health care organization trend line 104 indicates drug usage, this report 102 may be used to help predict needs for inventory and the like.

Referring now to FIGS. 3 and 7, the reporting of the ancillary drug usage data 72 may also be used to better allocate health care organization equipment, for example, by providing a tallying of accumulated operating time 105 for each pump 44. This information may be used to schedule maintenance or to rotate pumps in order to provide more for more even usage patterns per report generation process 110 shown in FIG. 3.

Certain terminology is used herein for purposes of reference only, and thus is not intended to be limiting. For example, terms such as “upper”, “lower”, “above”, and “below” refer to directions in the drawings to which reference is made. Terms such as “front”, “back”. “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. A system for aggregating anonymous medical data comprising:
a first set of medical pumps associated with a first medical institution having a first electronic medical record system;
a second set of medical pumps associated with a second medical institution having a second independent electronic medical record system;
a data aggregating server;
wherein each of the first and second medical pumps includes:
a wireless communication link; and
an electronic computer executing a program to:
(a) receive instruction data for delivery of drugs to patients by the pump;
(b) monitor operation of the pump during the delivery of drugs to the patient to provide monitor data; and
(c) wirelessly communicate anonymous data selected from the monitor data and the instruction data to the data aggregating server for production of aggregate medical data.

2. The system of claim 1 wherein the electronic computer further executes the program to: receive patient data for the patient receiving delivery of drugs, convert the patient data to anonymous patient data not identifying a particular patent, and wirelessly communicate the anonymized patient data to the data aggregating server.

3. The system of claim 2 wherein the patient data is at least one of a patient identity and a patient characteristic and the step of converting the patient data to anonymous patient data replaces the patient identity with a unique anonymous identifier.

4. The system of claim 1 wherein the electronic computer further executes the program to: receive a pump identification of the pump delivering the drug and wirelessly communicate a pump identification to the data aggregating server.

5. The system of claim 1 wherein the electronic computer further executes the program to: receive hospital data related to the hospital carrying the pump, convert the hospital data to anonymous hospital data not identifying a particular hospital, and wirelessly communicate the anonymous hospital data to the data aggregating server.

6. The system of claim 5 wherein the hospital data is at least one of a hospital identity and a healthcare organization characteristic and the step of converting the hospital data to anonymous hospital data replaces the hospital identity with a unique anonymous identifier.

7. The system of claim 1 wherein the electronic computer further executes the program to: receive healthcare practitioner data related to a practitioner operating the pump, convert the healthcare practitioner data to anonymous practitioner data not identifying a particular practitioner, and wirelessly communicate the anonymous practitioner data to the data aggregating server.

8. The system of claim 1 wherein the instruction data is at least one of a drug identity, a drug dose, and a drug flow rate.

9. The system of claim 1 wherein the monitor data is at least one of a volume of drug delivered and a time or date of drug delivery.

10. The system of claim 1 wherein the electronic computer anonymizes the data in a one-way hash function.

11. The system of claim 1 wherein the data aggregating server translates the anonymous data to a set of common data identifiers common to all anonymous data formats.

12. The system of claim 1 further comprising an electronic computer communicating with the data aggregating server and executing a program to generate a report displaying the aggregate medical data in graphic form.

13. The system of claim 1 further comprising an electronic computer communicating with the data aggregating server and executing a program to generate a report providing a total drug volume dispensed by a predetermined subset of medical pumps.

14. The system of claim 1 further comprising an electronic computer communicating with the data aggregating server and executing a program to generate a report of a common range of delivery rates for the aggregate medical data and produce an automatic alert when a delivery rate of a selected pump falls outside the common range.

15. The system of claim 1 further comprising an electronic computer communicating with the data aggregating server and executing a program to generate a report of total operation time of a selected pump.

16. A method for aggregating medical data from a plurality of medical institutions where each medical institutions has at least one medical pump having a housing adapted to receive an IV line, a pump for delivery of liquid medicament through the IV line, an input device for receiving drug delivery data, and a data aggregating server, the method comprising the steps of:
(a) transmitting drug delivery data to the input device of the pump;
(b) monitoring operation of the pump to produce monitor data;
(c) collecting at least one of the drug delivery data and monitor data;
(d) convert the at least one of the drug delivery data and monitor data to anonymous data;
(e) transmitting the anonymous data to the data aggregating server, and
(f) collecting the anonymous data with other anonymous data to produce aggregate medical data of the at least one medical pump at more than one medical institution.

17. A system for aggregating anonymous medical data from multiple medical institutions comprising:
a first medical device associated with a first medical institution having a first electronic medical record system;
a second medical device associated with a second medical institution having a second independent electronic medical record system;
a data aggregating server;
wherein each of the first and second medical devices include a wireless communication link to an electronic computer executing a program to:
(a) receive operating instruction data for the medical device;
(b) monitor operation of the medical device to provide monitor data;
(c) convert the data selected from the monitor data and the operating instruction data to produce anonymous data; and
(d) wirelessly communicate the anonymous data to the data aggregating server for production of aggregate medical data.
